(19) United States
(12) Patent Application Publication
(10) Pub. No.: US 2025/0242329 A1
(43) Pub. Date: Jul. 31, 2025

(54) CO2 REVERSIBLE ADSORPTION MATERIAL, COMPOSITION AND REGENERATION METHOD THEREOF, AND CO2 CAPTURE METHOD

(71) Applicants: CHINA ENERGY INVESTMENT CORPORATION LIMITED, Beijing (CN); NATIONAL INSTITUTE OF CLEAN-AND-LOW-CARBON ENERGY, Beijing (CN)

(72) Inventors: Xiaoying XU, Beijing (CN); Fuguo JIANG, Beijing (CN); Baodeng WANG, Beijing (CN); Zhengpu QIU, Beijing (CN); Bo FENG, Beijing (CN); Aihua XING, Beijing (CN); Jinghui JIA, Beijing (CN)

(21) Appl. No.: 18/847,082

(22) PCT Filed: Aug. 24, 2023
(86) PCT No.: PCT/CN2023/114680

§ 371 Date: Sep. 13, 2024

(30) Foreign Application Priority Data
Oct. 24, 2022 (CN) 202211303835.5

(51) Int. Cl. B01J 20/08; B01D 53/02; B01J 20/28; B01J 20/30; B01J 20/34

(52) U.S. Cl. CPC B01J 20/08; B01D 53/025; B01J 20/28061; B01J 20/28071; B01J 20/28073; B01J 20/2808; B01J 20/28083; B01J 20/3078; B01J 20/3433; B01J 20/3483; B01D 2253/1124; B01D 2253/306; B01D 2253/311; B01D 2257/504

(57) ABSTRACT

Use of a zinc-aluminum spinel particle as a CO₂ reversible adsorption material, a CO₂ reversible adsorption material and a CO₂ reversible adsorption composition, a CO₂ capture method and a regeneration method of the CO₂ reversible adsorption material or the CO₂ reversible adsorption composition. The zinc-aluminum spinel particle having a specific microstructure has a “micropore”+“mesopore” porous structure and a relatively high specific surface area, thus having a function of adsorbing and capturing CO₂ and being easy to regenerate, and is used as a CO₂ adsorption and capture material with great application potential. The CO₂ capture method can realize direct air capture of CO₂, can be adapted to a variety of application scenarios, and has good universal applicability.

### CROSS-REFERENCE TO RELATED APPLICATIONS

This application is a U.S. National Stage of International Patent Application No. PCT/CN2023/114680 filed Aug. 24, 2023, which claims priority to Chinese Patent Application No. 202211303835.5 filed Oct. 24, 2022, both of which are incorporated by reference herein as if reproduced in their entireties.

### TECHNICAL FIELD

The present disclosure relates to the field of inorganic materials, in particular to use of a zinc-aluminum spinel particle as a CO₂ reversible adsorption material, and further relates to a CO₂ reversible adsorption material and a CO₂ reversible adsorption composition, a CO₂ capture method and a regeneration method of the CO₂ reversible adsorption material or the CO₂ reversible adsorption composition.

### BACKGROUND

Substantial emissions of greenhouse gases lead to global climate warming issues. CO₂ is one of the primary gases that cause a greenhouse effect, wherein CO₂ produced by the combustion of petrochemical fuel is a primary source. CO₂ is the primary greenhouse gas, but is also a precious carbon resource. Therefore, the capture of CO₂ is of great significance to environmental protection and comprehensive utilization of carbon resources. In many existing CO₂ capture methods, an adsorption process is a relatively mature technology and used in most of the methods. The key to CO₂ capture is to seek adsorbents with high adsorption, high selectivity, good thermal stability and good cycle performance. In recent years, some porous materials such as activated carbon, zeolite molecular sieves, metal organic framework materials, porous organic polymers, melamine-based microporous polymers and other solid adsorption materials are widely used.

For example, Chinese patent CN114989442A discloses a method for preparing a novel ultra-microporous porous coordination polymer for CO₂ adsorption and capture, wherein a chemical formula of the prepared novel ultra-microporous porous coordination polymer is [Co(htpa)(dipyg)]n, wherein Co represents a metal center cobalt, htpa represents an organic ligand 2-hydroxyterephthalic acid, dipyg represents an organic ligand meso-α,β-Bis(4-pyridyl)glycol. The CO₂ can be efficiently adsorbed and captured in a plurality of mixed gases containing CO₂, CH₄, C₂H₂ and N₂, has high adsorption capacity and excellent desorption performance, and can be recycled repeatedly. However, the preparation process of the novel ultra-microporous porous coordination polymer obtained in this patent is complex, the cost is high, the industrial amplification potential is low, the preparation process of the organic ligand can pollute the environment, and the performance improvement such as cheap and easily available and environmental protection in the preparation process of the adsorption material is not concerned.

Chinese patent CN114307992A discloses a spherical solid amine CO₂ adsorption material, which is formed by crosslinking and curing polyethyleneimine as a matrix with a cross-linking agent, wherein the matrix comprises a temperature-sensitive group introduced by Michael addition. The spherical solid amine CO₂ adsorption material has a relatively high swelling rate, can reduce mass transfer resistance of CO₂ in the presence of water, thereby improving the adsorption capacity of wet CO₂, and can be quickly desorbed at a relatively low temperature, thereby reducing the regeneration energy consumption of the adsorption material. However, in the process of preparing the novel ultra-microporous porous coordination polymer, an organic ligand needs to be introduced, the preparation process is complex, and a thermal stability performance is not ideal.

At present, although the CO₂ adsorption material is rapidly developed, in view of reducing the urgency of CO₂ gas emission, there is still a need to find a CO₂ adsorption material which is simple and convenient to prepare, low in cost, easy to regenerate and wide in application scenario.

### SUMMARY

In order to solve the problems in the prior art, an object of the present disclosure is to provide use of a zinc-aluminum spinel particle as a CO₂ reversible adsorption material, which is simple and convenient to prepare, high in adsorption speed and easy to regenerate.

Another object of the present disclosure is to provide a CO₂ reversible adsorption material and a CO₂ reversible adsorption composition.

A further object of the present disclosure is to provide a CO₂ capture method.

Another object of the present disclosure is to provide a regeneration method of the CO₂ reversible adsorption material and the CO₂ reversible adsorption composition.

The present disclosure provides use of a zinc-aluminum spinel particle as a CO₂ reversible adsorption material, wherein the zinc-aluminum spinel particle has a specific surface area of 190-380 m²/g (for example, 195 m²/g, 200 m²/g, 220 m²/g, 250 m²/g, 300 m²/g, 320 m²/g and 350 m²/g), and comprising 5-13% (for example, 6%, 8%, 10% and 12%) of micropores and 87-95% (for example, 88%, 90%, 92% and 94%) of mesopores in percentage by volume.

The inventors of the present disclosure have found that the zinc-aluminum spinel particle (ZnAl₂O₄) of the present disclosure has a porous structure with “micropores (i.e., pore size <2 nm)”+“mesopores (i.e., pore size of 2-50 nm)”, and have a relatively high specific surface area, and therefore can directly act with H₂O and CO₂ in the air to form a specific basic carbonate structure having a certain degree of crystallinity, thereby achieving an effect of adsorbing and capturing CO₂. Other zinc-aluminum spinel particles having different microstructures (such as the product prepared in Comparative Example 1) cannot form the basic carbonate structure under the same conditions, and thus do not have a corresponding CO₂ adsorption function.

In addition, the zinc-aluminum spinel particle of the present disclosure is convenient to regenerate, and can be basically restored to an original spinel structure after regeneration treatment, so that the adsorption and desorption of the CO₂ can be repeated repeatedly and repeatedly, a capture cost of the CO₂ is reduced, and the practicability is high. Therefore, the zinc-aluminum spinel particle according to the present disclosure may be used for Direct Air Capture (DAC) of CO₂, and is a CO₂ reversible adsorption material with very great application potential.

The present disclosure further provides a CO₂ reversible adsorption material, which is a zinc-aluminum spinel particle, wherein the zinc-aluminum spinel particle has a specific surface area of 190-380 m²/g (for example, 195 m²/g, 200 m²/g, 220 m²/g, 250 m²/g, 300 m²/g, 320 m²/g and 350 m²/g), and comprising 5-13% (for example, 6%, 8%, 10% and 12%) of micropores and 87-95% (for example, 88%, 90%, 92% and 94%) of mesopores in percentage by volume.

The present disclosure further provides a CO₂ reversible adsorption composition, comprising, in percentage by weight, 10-90% (for example, 15%, 20%, 25%, 30%, 40%, 50%, 60% and 80%) of zinc-aluminum spinel particle (i.e. the CO₂ reversible adsorption material according to any one of the above technical solutions) and the balance of water, wherein the zinc-aluminum spinel particle has a specific surface area of 190-380 m²/g, and comprises 5-13% of micropores and 87-95% of mesopores in percentage by volume.

The inventors of the present disclosure have also found that the zinc-aluminum spinel particle according to the present disclosure can significantly accelerate the adsorption and capture of the CO₂ in the presence of water, and the adsorption time can be shortened from several weeks to one day or several hours under the same CO₂ adsorption amount, or even shortened to more than ten minutes.

In the CO₂ reversible adsorption composition provided by the present disclosure, an amount of water used may also adjust the adsorption rate, which may be about 10%, about 20%, about 30%, about 40%, about 50%, about 60%, about 70%, about 80%, about 90%, or may be a weight percentage range of any combination, by weight. In some preferred embodiments, the CO₂ reversible adsorption composition may comprise 40-60% of zinc-aluminum spinel particle and the balance of water in percentage by weight.

In the CO₂ reversible adsorption composition provided by the present disclosure, the zinc-aluminum spinel particle and the water may be uniformly mixed in any common manner, thereby obtaining the composition.

The present disclosure further provides a CO₂ capture method, wherein the capture method uses the CO₂ reversible adsorption material according to any one of the foregoing technical solutions or the CO₂ reversible adsorption composition according to any one of the foregoing technical solutions to capture CO₂ in the air.

In the CO₂ capture method provided by the present disclosure, a relative humidity of the air may be 20-100% (for example, 25%, 35%, 40%, 55%, 60%, 65%, 70% and 95%). In some preferred embodiments, the relative humidity of the air may be 30-90%. In some more preferred embodiments, the relative humidity of the air may be 50-80%.

In the CO₂ capture method provided by the present disclosure, an ambient temperature during CO₂ capture may be 15-80° C. (for example, 35° C., 45° C. and 60° C.). In some preferred embodiments, the ambient temperature during CO₂ capture may be 20-50° C., for example, may be 30-40° C.

The CO₂ capture process provided by the present disclosure is preferably used for CO₂ capture in the air at room temperature, which refers to a temperature of 20-25° C. and an air relative humidity of 50-80%.

The present disclosure further provides a regeneration method of the CO₂ reversible adsorption material according to any one of the above technical solutions or the CO₂ reversible adsorption composition according to any one of the above technical solutions, wherein the method comprises the step of heating the zinc-aluminum spinel particle after the capture of CO₂ at a temperature of 70-400° C.

In the regeneration method provided by the present disclosure, the higher a heating temperature is, the faster a CO₂ desorption rate is; therefore, the heating temperature may be selected based on an amount of materials to be regenerated and based on the consideration of energy consumption, for example, the heating temperature may be about 70° C., about 100° C., about 150° C., about 200° C., about 250° C., about 300° C., about 350° C., about 400° C., or may be in any combination of temperature intervals. In some preferred embodiments, the heating temperature may be 100-300° C.

In the regeneration method provided by the present disclosure, a heating time may be determined according to different heating temperatures and different CO₂ adsorption amounts. Usually, heating can make a basic carbonate structure in the zinc-aluminum spinel particle disappear, and the regeneration process is completed when an original spinel structure is basically restored. After regeneration, properties of the zinc-aluminum spinel particle in the present disclosure remain basically unchanged, so the zinc-aluminum spinel particle can be recycled for many times, for example, the zinc-aluminum spinel particle can withstand at least 100 cycles of “adsorption-desorption”.

In the regeneration method provided by the present disclosure, a gas recovery device may also be provided at the same time for collecting and sealing CO₂ gas released in the regeneration process, wherein the gas recovery device may be common device in the field. In some preferred embodiments, a condensation device may also be provided at the same time to remove moisture contained in the released gas by condensation.

In the above technical solutions provided by the present disclosure (for example, the use of the zinc-aluminum spinel particle as the CO₂ reversible adsorption material, the CO₂ reversible adsorption material and the CO₂ reversible adsorption composition, the CO₂ capture method, and the regeneration method of the CO₂ reversible adsorption material and the CO₂ reversible adsorption composition, etc.), the zinc-aluminum spinel particle has the specific surface area of about 190 m²/g, about 200 m²/g, about 230 m²/g, about 250 m²/g, about 280 m²/g, about 300 m²/g, about 320 m²/g, about 350 m²/g, about 380 m²/g, or may be any combination of specific surface area intervals. In some preferred embodiments, the zinc-aluminum spinel particle has the specific surface area of 230-350 m²/g. In some more preferred embodiments, the zinc-aluminum spinel particle has the specific surface area of 230-280 m²/g.

In the technical solution provided by the present disclosure, the zinc-aluminum spinel particle may further comprise 5-13% of micropores, 75-85% of 2-10 nm mesopores and 7-12% of mesopores greater than or equal to 10 nm in percentage by volume.

In the technical solution provided by the present disclosure, the zinc-aluminum spinel particle may have an average particle size of 2-10 nm, for example, about 2 nm, about 3 nm, about 4 nm, about 5 nm, about 6 nm, about 7 nm, about 8 nm, about 9 nm and about 10 nm, or may be any combination of particle size ranges. In some preferred embodiments, the zinc-aluminum spinel particle may have an average particle size of 3-6 nm.

In the technical solution provided by the present disclosure, the zinc-aluminum spinel particle has a pore volume of 0.3-1.2 cm³/g, for example, about 0.3 cm³/g, about 0.5 cm³/g, about 0.8 cm³/g, about 1.0 cm³/g, about 1.2 cm³/g, or may be any combination of volume intervals.

In the technical solution provided by the present disclosure, analysis by XRD and Transmission Electron microscope (TEM) shows that the zinc-aluminum spinel particle hardly contains dispersed zinc oxide (ZnO) nanoparticles.

In the technical solution provided by the present disclosure, a method for preparing the zinc-aluminum spinel particle comprises the following steps of:
S1: respectively preparing a salt solution with a volume of V and containing Zn²⁺ and Al³⁺ and a precipitant solution;
S2: adding an alkali liquor with a pH value of 9-10 into a reaction container, and then dripping the salt solution and the precipitant solution into the reaction container in parallel at the same speed for coprecipitation, wherein, in terms of volume, the pH value is controlled to be 7-9 when the first 20-50% of V is dripped, and the pH value is controlled to be reduced at a reduction range of 1-20% when the rest solution is dripped; and
S3: aging after the coprecipitation is finished, and then drying and calcining the obtained solid at 300-400° C. to obtain the zinc-aluminum spinel particle.

The preparation method adopts a coprecipitation process, and under the joint action of a series of process conditions such as temperature, solution flow rate, pH value and the like, the raw materials form a precursor through the coprecipitation process, and then a microstructure and a morphology of the precursor are further stabilized through aging, and then a spinel material with a porous structure and a large specific surface area is formed through drying and low-temperature calcination.

In the above preparation method, a molar ratio of Zn²⁺ to Al³⁺ in the salt solution containing Zn²⁺ and Al³⁺ may be 0.5-1.5:2, for example, may be about 0.5:2, about 0.8:2, about 1:2, about 1.2:2 and about 1.5:2 may be any combination of molar ratio ranges. Metal ions used to form the salt solution may be sourced from respective soluble salts or hydrates thereof, for example, nitrate, carbonate, chloride, sulfate or respective hydrates thereof.

A concentration of the salt solution containing Zn²⁺ and Al³⁺ may be 0.1-0.5 mol/L, for example, 0.15 mol/L, 0.2 mol/L, 0.25 mol/L, 0.3 mol/L and 0.4 mol/L.

In the preparation method, in the precipitant solution, the precipitant may be one or more of sodium carbonate, sodium bicarbonate, potassium carbonate, potassium bicarbonate, ammonium carbonate and ammonium bicarbonate, and a concentration of the precipitant may be 0.1-0.5 g/mL (for example, 0.2 g/mL, 0.3 g/mL and 0.4 g/mL). In some preferred embodiments, the precipitant may be sodium carbonate.

In the above preparation method, the alkali liquor may be an aqueous solution formed by one or more of sodium carbonate, sodium bicarbonate, potassium carbonate, potassium bicarbonate, ammonium carbonate and ammonium bicarbonate, and a concentration of the alkali liquor may be 0.05-2 mol/L (for example, 0.1 mol/L, 0.2 mol/L, 0.5 mol/L, 1 mol/L and 1.5 mol/L). A type of the alkali liquor may be the same as or different from the precipitant solution.

In the above preparation method, regarding “the pH value is controlled to be 7-9 when the first 20-50% of V is dripped”, those skilled in the art can understand this expression as that the pH value is controlled to be 7-9 when the 20-50% of the respective volumes of the salt solution and the precipitant solution in parallel.

In the above preparation method, an addition volume of the alkali liquor is 40-60% (volume ratio) of V, for example, may be about 40%, about 45%, about 50%, about 55% and about 60% or may be any combination of volume ratio ranges. In some preferred embodiments, the addition volume of the alkali liquor is 50% of V. Regarding “the addition volume of the alkali liquor is 40-60% (volume ratio) of V”, those skilled in the art can understand this expression as that the addition volume of the alkali liquor is 40-60% of any volume V in the salt solution or the precipitant solution.

In the above preparation method, a temperature of the coprecipitation may be 60-80° C., for example, may be about 60° C., about 65° C., about 70° C., about 75° C. and about 80° C., or may be any combination of temperature ranges.

In the above preparation method, a dripping speed of the salt solution and the precipitant solution is 0.75-1.5% (for example, 0.8%, 1% and 1.2%) of a dripping volume of V per minute. Too fast or too slow dripping speed will affect a micro-morphology of a target product, and an expected product cannot be obtained. The dripping speed of the salt solution and the precipitant solution is 0.75-1.5% of the volume of V per minute, and those skilled in the art can understand this expression as that the dripping speed of the salt solution and the precipitant solution is 0.75-1.5% of respective volumes V thereof per minute.

In the above preparation method, a coprecipitation system as a whole is strongly alkaline due to the pre-added alkali liquor, and a pH value of the coprecipitation system gradually decreases with the parallel dripping of the salt solution and the precipitant solution; in this case, a decrease range of the pH value is controlled within a certain range to avoid large changes affecting the microstructure of the target product. In some preferred embodiments, when the first 20-50% (for example, 25%, 30% and 40%, or any combination interval) of V is dripped, the pH value is controlled to be 7-9, and when the rest solution is dripped, the pH value is controlled to be reduced at a reduction range of 2-20%, for example, may be about 2%, about 5%, about 10%, about 12%, about 15%, about 18% and about 20%, or may be any combination interval.

In the above preparation method, the aging may be carried out at the same temperature as the coprecipitation, or may be carried out at a temperature slightly higher than the coprecipitation temperature, and those skilled in the art can adjust the temperature accordingly. In some preferred embodiments, the aging and the coprecipitation may be carried out at the same temperature, and an aging time may be 0.5-24 h (for example, 1.0 h, 2.0 h, 4.0 h, 10 h and 20 h), for example, the aging time may be 0.5-5 h.

In the above preparation method, after the aging, the obtained solid is separated and washed, for example, with water, and a washing degree is preferably that a conductivity of an eluate is less than 50 μS/cm.

In the above preparation method, a purpose of drying is to remove the residual free water after washing, and a drying temperature may be 80-120° C. and a drying time may be 10-16 h. In some preferred embodiments, a degree of drying is that a moisture content of the material is less than 3 wt %, and more preferably, it is dried until the moisture content of the material is less than 1 wt %.

In the above preparation method, the calcination may be low temperature calcination, which is beneficial to controlling a grain size, a calcination temperature may be 300-350° C. (for example, 310° C., 320° C. and 340° C.) and a calcination time can be 3-6 h (for example, 4 h and 5 h).

In the above preparation method, required materials may be obtained through a separation step, for example, after aging, solid objects are obtained through separation, and a separation method may be common in the field, comprising but not limited to natural sedimentation, (normal pressure or vacuum) filtration, centrifugation and the like.

The technical solution provided by the present disclosure has the following advantages:
1) The present disclosure finds a new use of the zinc-aluminum spinel particle having a specific microstructure, which has a “micropore”+“mesopore” porous structure and a relatively high specific surface area, thus having a function of adsorbing and capturing CO₂, and is used as a CO₂ adsorption and capture material with great application potential.
2) After absorbing and capturing CO₂, the zinc-aluminum spinel particle having a specific microstructure is easy to regenerate, and the CO₂ can be desorbed only by heating, with low energy consumption and excellent adsorption after regeneration, so that the process of “adsorption-desorption” can be performed repeatedly and repeatedly, and the CO₂ capture cost can be significantly reduced.
3) The preparation process of the zinc-aluminum spinel particles is simple, does not need to use a variety of additives (such as reaming agent, sodium meta-aluminate, etc.), has mild conditions, strong feasibility and good repeatability, and is suitable for large-scale industrial production.
4) The CO₂ capture method provided by the present disclosure can realize direct air capture of CO₂, can be adapted to various application scenarios, has good universal applicability, and the desorbed CO₂ gas can also be conveniently collected and sealed, so it is expected to provide assistance for realizing the goal of double carbon, which not only has very important economic significance, but also has very important social significance.

### BRIEF DESCRIPTION OF THE DRAWINGS

In order to more clearly illustrate the technical solutions of the embodiments of the present disclosure, the drawings required in the examples will be briefly described below. It should be understood that the following drawings illustrate only certain examples of the present disclosure, and therefore should not be regarded as limiting the scope of the present disclosure.

FIG. 1 is a TEM image of a zinc-aluminum spinel particle prepared in Example 1, wherein FIG. 1A is a TEM image of the zinc-aluminum spinel particle (scale: 5 nm), FIG. 1B is a partially enlarged image of FIG. 1A, and FIG. 1C is a standard schematic structural diagram of the zinc-aluminum spinel particle.

FIG. 2 is a TEM image (scale: 20 nm) of the zinc-aluminum spinel particle prepared in Example 1.

FIG. 3 is a graph of nitrogen physical adsorption and desorption of zinc-aluminum spinel particles prepared in Examples 1-4.

FIG. 4 is a TEM image of a zinc-aluminum spinel particle prepared in Comparative Example 1.

FIG. 5 is an XRD pattern of the zinc-aluminum spinel particle prepared in Example 1 at different adsorption times.

FIG. 6 is an XRD pattern of the zinc-aluminum spinel particle prepared in Example 1 at different degrees of crystallinity.

### DETAILED DESCRIPTION

The embodiments of the present disclosure will be described in detail below with reference to specific embodiments, but those skilled in the art will understand that the following embodiments are only used to illustrate the present disclosure, and should not be regarded as limiting the scope of the present disclosure. Those embodiments without indicating specific conditions are carried out according to conventional conditions or conditions suggested by the manufacturers. Those reagents or instruments without indicating manufacturers are all conventional products that can be obtained through commercially available purchases.

Raw materials or reagents used in the embodiments and comparative examples of the present disclosure are all commercially available.

Percentages used in the embodiments and comparative examples of the present disclosure are all mass percentages unless otherwise specified.

In the embodiments and comparative examples of the present disclosure, a specific surface area and a pore structure of an obtained product can be obtained through a test result of a nitrogen physical adsorption instrument, a pore volume of the product is calculated, and the test result is shown in FIG. 3 (the higher a closed-loop area formed by a desorption curve, the larger the specific surface of the product, and a hysteresis loop appearing between relative pressures of 0.6-1 indicates that the obtained product structure has a mesopore of 2-50 nm).

A method for calculating a degree of crystallinity used in the test example of the present disclosure is as follows:

Diffraction peak areas of basic carbonate (characteristic diffraction peak at 10°, 24°, 35°, 38° and 47°) and zinc-aluminum spinel (characteristic diffraction peak is the wide peak between 30° and 40°) were calculated using XRD data processing software EVA of Bruker Corporation, denoted as S_{c} and Sₘₑ respectively, and a peak area of an amorphous portion in a zinc-aluminum spinel phase was described as Sₘₘ using “background” function in EVA, a ratio of (S_{c}+S_{mc})/(S_{c}+S_{mc}+Sₘₘ) represents a relative content of the crystalline phase in the sample to evaluate a degree of crystallinity of the crystalline phase after the zinc-aluminum spinel absorbs CO₂. That is, the degree of crystallinity %=(S_{c}+S_{mc})/(S_{c}+S_{mc}+Sₘₘ)×100%.

The “air at room temperature” in the test example of the present disclosure refers to an air temperature of 21-25° C. and a relative humidity of 50-70%.

### Example 1

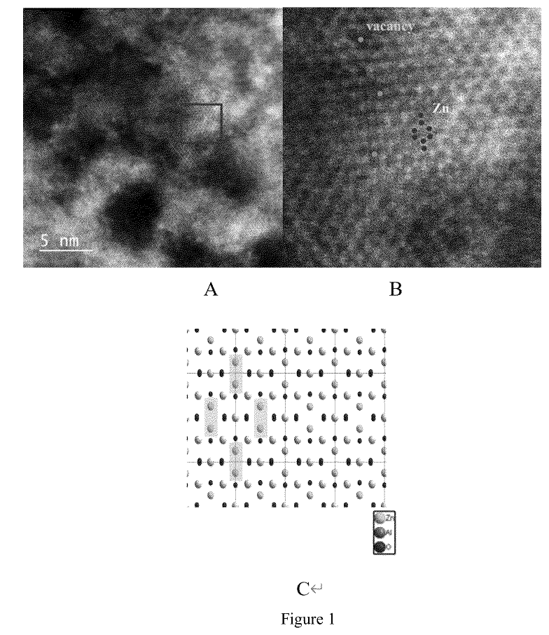

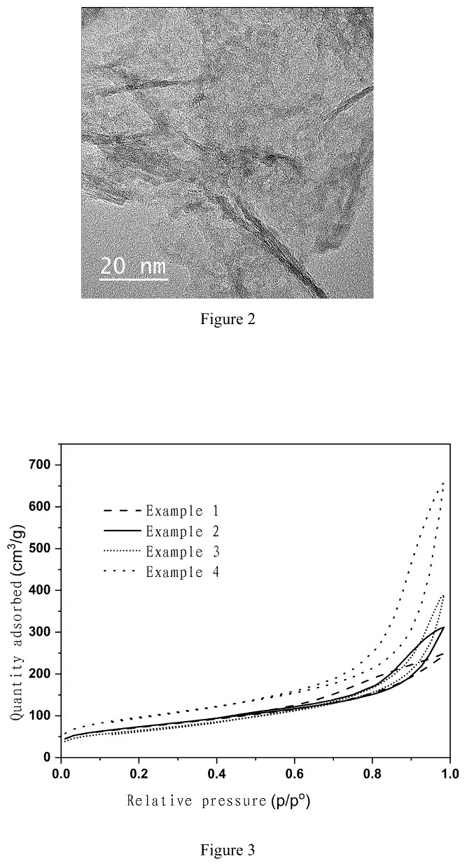

828 g of zinc nitrate hexahydrate and 2,087 g of aluminum nitrate nonahydrate were weighed and added with water to prepare a 4 L aqueous solution for use, and recorded as a precipitant A. 1,200 g of sodium carbonate was weighed and added with water to prepare a 4 L aqueous solution for later use, and recorded as a precipitant B. In a 10 L reaction kettle, firstly, 2 L of potassium bicarbonate with a concentration of 0.1 mol/L was added to a bottom of the kettle, and then the precipitant A and the precipitant B began to be dripped in parallel, keeping the precipitant A and the precipitant B to be precipitated at a constant speed of 40 mL/min and controlling a temperature of the reaction kettle to be 70° C., controlling the pH value to 8 when the first 30% (volume ratio) of solution (i.e., the first 30% of the respective volumes of the precipitant A and the precipitant B were dripped in parallel) was dripped and controlling a pH value to 7 when the later 70% (volume ratio) of solution (i.e., the later 70% of the respective volumes of the precipitant A and the precipitant B were dripped in parallel) was dripped. After the precipitation, the reaction solution was continuously stirred for 0.5 h at the same temperature and then cooled down. The mixture was filtered. A filter cake was washed repeatedly until a conductivity of an eluate was less than 50 μS/cm, and dried at 110° C. for 15 h to remove free water in the filter cake to form a precursor with a moisture content less than 1%. The precursor was transferred to a muffle furnace for calcination, and a calcination temperature was controlled at 350° C. After calcining for 5 h, the zinc-aluminum spinel particles were obtained, and TEM images thereof were shown in FIG. 1A and FIG. 2.

As shown in FIG. 1, it can be seen from FIG. 1B and FIG. 1C that the obtained particles are of a zinc-aluminum spinel structure, and does not contain dispersed ZnO particles.

The zinc-aluminum spinel particles have an average size of 3.8 nm. In the spinel particles, a ratio of micropores less than 2 nm accounts for 9%, a ratio of pores of 2-10 nm accounts for 84%, and a ratio of pores of 10-50 nm accounts for 7%, a specific surface area is 258.7 m²/g, and a pore volume is 0.38 cm³/g.

### Example 2

828 g of zinc nitrate hexahydrate and 2,087 g of aluminum nitrate nonahydrate were weighed and added with water to prepare a 4 L aqueous solution for use, and recorded as a precipitant A. 1,000 g of sodium carbonate was weighed and added with water to prepare a 4 L aqueous solution for later use, and recorded as a precipitant B. In a 10 L reaction kettle, firstly, 2 L of sodium bicarbonate with a concentration of 0.05 mol/L was added to a bottom of the kettle, and then the precipitant A and the precipitant B began to be dripped in parallel, keeping the precipitant A and the precipitant B to be precipitated at a constant speed of 50 mL/min and controlling a temperature of the reaction kettle to be 80° C., controlling a pH value to 8 when the first 20% (volume ratio) of solution (i.e., the first 20% of the respective volumes of the precipitant A and the precipitant B were dripped in parallel) was dripped and controlling the pH value to 6.5 when the later 80% (volume ratio) of solution (i.e., the later 80% of the respective volumes of the precipitant A and the precipitant B were dripped in parallel) was dripped. After the precipitation, the reaction solution was continuously stirred for 1 h at the same temperature and then cooled down. The mixture was filtered. A filter cake was washed repeatedly until a conductivity of an eluate was less than 50 μS/cm, and dried at 110° C. for 10 h to remove free water in the filter cake to form a precursor with a moisture content less than 1%. The precursor was transferred to a muffle furnace for calcination, and a calcination temperature was controlled at 300° C. After calcining for 3 h, the zinc-aluminum spinel particles were obtained.

The zinc-aluminum spinel particles have an average size of 4.8 nm. In the spinel particles, a ratio of micropores less than 2 nm accounts for 9%, a ratio of pores of 2-10 nm accounts for 82%, and a ratio of pores of 10-50 nm accounts for 9%, a specific surface area is 264.1 m²/g, and a pore volume is 0.48 cm³/g

### Example 3

828 g of zinc nitrate hexahydrate and 2,087 g of aluminum nitrate nonahydrate were weighed and added with water to prepare a 4 L aqueous solution for use, and recorded as a precipitant A. 1,300 g of sodium carbonate was weighed and added with water to prepare a 4 L aqueous solution for later use, and recorded as a precipitant B. In a 10 L reaction kettle, firstly, 2 L of ammonium bicarbonate with a concentration of 1.5 mol/L was added to a bottom of the kettle, and then the precipitant A and the precipitant B began to be dripped in parallel, keeping the precipitant A and the precipitant B to be precipitated at a constant speed of 60 mL/min and controlling keeping a temperature of the reaction kettle to be 75° C., controlling a pH value to 9 when the first 50% (volume ratio) of solution (i.e., the first 50% of the respective volumes of the precipitant A and the precipitant B were dripped in parallel) was dripped and controlling the pH value to 8 when the later 50% (volume ratio) of solution (i.e., the later 50% of the respective volumes of the precipitant A and the precipitant B were dripped in parallel) was dripped. After the precipitation, the reaction solution was continuously stirred for 1 h at the same temperature and then cooled down. The mixture was filtered. A filter cake was washed repeatedly until a conductivity of an eluate was less than 50 μS/cm, and dried at 110° C. for 16 h to remove free water in the filter cake to form a precursor with a moisture content less than 1%. The precursor was transferred to a muffle furnace for calcination, and a calcination temperature was controlled at 320° C. After calcining for 5 h, the zinc-aluminum spinel particles were obtained.

The zinc-aluminum spinel particles have an average size of 5.1 nm. In the spinel particles, a ratio of micropores less than 2 nm accounts for 6%, a ratio of pores of 2-10 nm accounts for 82%, and a ratio of pores of 10-50 nm accounts for 12%, a specific surface area is 233.5 m²/g, and a pore volume is 0.35 cm³/g.

### Example 4

828 g of zinc nitrate hexahydrate and 2,087 g of aluminum nitrate nonahydrate were weighed and added with water to prepare a 4 L aqueous solution for use, and recorded as a precipitant A. 1,200 g of sodium carbonate was weighed and added with water to prepare a 4 L aqueous solution for later use, and recorded as a precipitant B. In a 10 L reaction kettle, firstly, 2 L of alkali liquor (mixture of sodium bicarbonate to potassium bicarbonate in a mass ratio of 1:1) with a concentration of 0.01 mol/L was added to a bottom of the kettle, and then the precipitant A and the precipitant B began to be dripped in parallel, keeping the precipitant A and the precipitant B to be precipitated at a constant speed of 30 mL/min and controlling a temperature of the reaction kettle to be 60° C., controlling a pH value to 7 when the first 30% (volume ratio) of solution (i.e., the first 30% of the respective volumes of the precipitant A and the precipitant B were dripped in parallel) was ripped and controlling the pH value to 6.8 when the later 70% (volume ratio) of solution (i.e., the later 70% of the respective volumes of the precipitant A and the precipitant B were dripped in parallel) was dripped. After the precipitation, the reaction solution was continuously stirred for 1 h at the same temperature and then cooled down. The mixture was filtered. A filter cake was washed repeatedly until a conductivity of an eluate was less than 50 μS/cm, and dried at 110° C. for 14 h to remove free water in the filter cake to form a precursor with a moisture content less than 3%. The precursor was transferred to a muffle furnace for calcination, and a calcination temperature was controlled at 320° C. After calcining for 5 h, the zinc-aluminum spinel particles were obtained.

The zinc-aluminum spinel particles have an average size of 3.4 nm. In the spinel particles, a ratio of micropores less than 2 nm accounts for 12%, a ratio of pores of 2-10 nm accounts for 82%, and a ratio of pores of 10-50 nm accounts for 12%, a specific surface area is 348.2 m²/g, and a pore volume is 1.01 cm³/g.

### Comparative Example 1

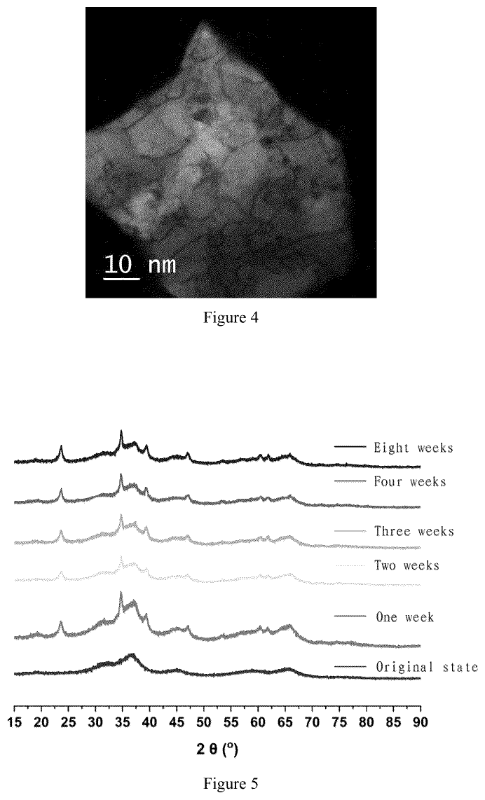

828 g of zinc nitrate hexahydrate and 2,087 g of aluminum nitrate nonahydrate were weighed and added with water to prepare a 4 L aqueous solution for use, and recorded as a precipitant A. 1,200 g of sodium carbonate was weighed and added with water to prepare a 4 L aqueous solution for later use, and recorded as a precipitant B. In a 10 L reaction kettle, the precipitant A and the precipitant B were dripped in parallel, keeping the precipitant A and the precipitant B to be precipitated at a constant speed and controlling a temperature of the reaction kettle to be 80° C., controlling a pH value in the reaction kettle to be 8. A flow rate of the precipitant A and the precipitant B was 100 mL/min. After the precipitation, the reaction solution was continuously stirred for 2-3 h at the same temperature and then cooled down. The mixture was filtered. A filter cake was dried until a moisture content thereof was less than 1%, and then transferred to a muffle furnace for calcination at a calcination temperature of 700° C., calcining for 5 h, and then taking out to obtain the zinc-aluminum spinel particles, a TEM image of which was shown in FIG. 4.

The zinc-aluminum spinel particles have an average size of 36 nm, are single pore domain materials of 50 nm or more, have a specific surface area of 60 m²/g, and a pore volume of 0.14 cm³/g.

### Comparative Example 2

ZnO and Al₂O₃ were physically mixed according to an atomic molar ratio of ZnAl₂O₄ (i.e. a molar ratio of ZnO to Al₂O₃ being 1:1) to obtain a mixture.

### Comparative Example 3

Basic zinc carbonate and Al₂O₃ were physically mixed according to an atomic molar ratio of ZnAl₂O₄ (i.e. a molar ratio of Zn₂(OH)₂CO₃ to Al₂O₃ being 1:2) to obtain a mixture.

### Test Example 1

The product samples prepared in Examples 1-4 and Comparative Examples 1-3 were placed directly into air at room temperature for two weeks, subjected to XRD test once, continuously placed for four weeks, then subjected to XRD test once, and the results were shown in Table 1.

TABLE 1

| | | Test result after | Test result after |
|---|---|---|---|
| | | two weeks | four weeks |
| Serial | | (Degree of | (Degree of |
| No. | Source of test sample | crystallinity) | crystallinity) |
| 1 | Example 1 | 13% | 27% |
| 2 | Example 2 | 18% | 32% |
| 3 | Example 3 | 10% | 25% |
| 4 | Example 4 | 15% | 30% |
| 5 | Comparative Example 1 | — | — |
| 6 | Comparative Example 2 | — | — |
| 7 | Comparative Example 3 | — | — |

The test results in Table 1 show that the zinc-aluminum spinel particle products prepared in Examples 1-4 could directly react with the moisture and the CO₂ in the air. After two weeks, the XRD test results show that new diffraction peaks appeared near 10°, 24°, 35°, 38° and 47°. According to the comparison with a standard spectrum (PDF48-1023), a basic carbonate structure containing zinc-aluminum (expressed as (Al_{0.31}Zn_{0.7})(OH)₂(CO₃)_{0.167}·H₂O) appeared in the material. Continuing to place the products in the air for reaction with the moisture and the CO₂, as the basic carbonate structure increased, the crystallinity was further increased. After four weeks, the crystallinity reached a range of 25-32%.

The product of Example 1 was continuously placed for eight weeks, and the original product and the products after each week were tested by XRD, as shown in FIG. 5 (mainly showing the characteristic diffraction peaks greater than or equal to 15). It could be seen that there were no characteristic diffraction peaks near 10°, 24°, 35°, 38° and 47° in the spectrogram of the original product. After being placed in the air, the characteristic diffraction peak of the basic carbonate began to appear, and the crystallinity was gradually increased with the extension of the placing time.

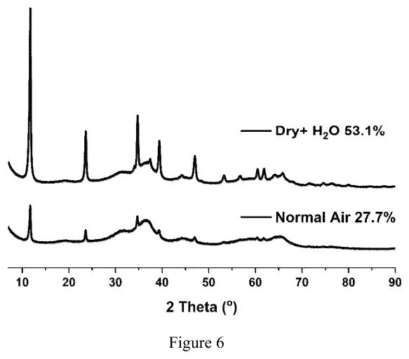

The degree of crystallinity of the product of Example 1 after placing for eight weeks reached 27.7%. The product was dried in an oven at 125° C. for 10 h until the characteristic diffraction peak in the XRD pattern disappeared; and then 1.2 times of water in terms of weight was added to the regenerated spinel product obtained, stirred uniformly and continuously placed in the air at room temperature for a period of time. The XRD pattern showed that the characteristic diffraction peak of the basic carbonate appeared again, and in this case, the crystallinity reached 53.1%, as shown in FIG. 6.

In contrast, after the products prepared in Comparative Examples 1-3 were placed for two weeks, the XRD results showed that the characteristic diffraction peak of the basic carbonate was not found, indicating that the corresponding basic carbonate structure containing zinc-aluminum was not formed. The formation of the basic carbonate structure was not found after four weeks.

The test results of Comparative Example 1 showed that even if the same zinc-aluminum spinel materials were used, the material of Comparative Example 1 cannot achieve the function of adsorbing the CO₂ in the air due to the difference of the microstructure, especially the difference between the pore structure and the specific surface area.

The test results of Comparative Example 2 showed that although the resulting mixture had the same element composition as the spinel products of the examples, the resulting mixture included two different phases, which were different from the spinel phase structure, and thus cannot achieve the function of adsorbing the CO₂ in the air.

The mixture product prepared in Comparative Example 3 was heated at 125° C. to convert the basic zinc carbonate therein to ZnO, placed in the air at room temperature for two weeks, and then subjected to XRD test. The results showed that the formation of the basic carbonate structure was still not found, which also sidewise illustrated the basic carbonate formed by the zinc-aluminum spinel particles products of the examples after adsorption of the CO₂ (i.e. a specific basic carbonate structure with a certain crystallinity) was not a conventional basic zinc carbonate.

### Test Example 2

10 g of the product samples prepared in Examples 1-4 and Comparative Examples 1-3 were weighed; and then 1.2 times of water in terms of weight was added, stirred uniformly and placed in the air at room temperature, the samples were reacted with the CO₂ in the air for 15 h and then subjected to XRD test and the crystallinity was calculated.

The test results showed that the samples in Examples 1-4 all formed a basic carbonate structure containing zinc-aluminum (the degrees of crystallinity were about 52%, 57%, 48% and 41% respectively, and the adsorption capacity of CO₂ was about 3.2-3.7% in terms of weight, which could be obtained by conversion). Thus, the zinc-aluminum spinel products in the examples compounded with water accelerated the CO₂ adsorption rate.

The test results showed that no corresponding basic carbonate structure was found in the products prepared in Comparative Examples 1-3, and the function of adsorbing the CO₂ in the air cannot be achieved after compounding with water.

### Test Example 3

The product obtained in Example 2 after CO₂ adsorption in Test Example 2 was placed in an oven at 110° C. for drying for 4 h, the obtained sample was increased by 8.3% relative to an original weight (in this case, the degree of crystallinity was about 57%), the sample was continuously placed in an oven at 150° C. and dried for 10 h, and the weight of the sample was further lost until the original spinel weight was recovered, thereby achieving regeneration of the zinc-aluminum spinel product.

The operation of Test Example 2 was repeated, and then water was added to the regenerated spinel product again according to a weight ratio of 1:1.2, stirred uniformly and then placed in the air at room temperature. After the sample was reacted with the CO₂ in the air for 10 h, XRD test was performed, and the results showed that the basic carbonate structure was found, and crystallinity was about 48%. The sample was placed in an oven at 110° C. and dried for 4 h to remove free water in the sample, and the sample was increased by 8.2% relative to the original weight, the sample was continuously placed in an oven at 150° C. for 10 h, and the original spinel weight was recovered. XRD test showed that the original spinel structure was recovered again.

The above cycle of “adsorbing CO₂ by adding water—and releasing CO₂ by heating” was repeated until the spinel structure in the tenth cycle was substantially unchanged. After the tenth cycle, the structure begun to have very little loss which was no more than 1%. Thus, it could be inferred that the zinc-aluminum spinel of the present disclosure could at least last for 100 cycles of “adsorbing CO₂ by adding water—and releasing CO₂ by heating”.

Unless specifically limited, the terms used in the present disclosure are all meanings commonly understood by those skilled in the art.

The embodiments described herein are for illustrative purposes only and are not intended to limit the scope of the present disclosure, and those skilled in the art can make various other substitutions, changes and improvements within the scope of the present disclosure, and therefore, the present disclosure is not limited to the above embodiments, but only limited by the claims.

1. (canceled)

2. A CO₂ reversible adsorption material, which is a zinc-aluminum spinel particle, wherein the zinc-aluminum spinel particle has a specific surface area of 190-380 m²/g, and comprising 5-13% of micropores and 87-95% of mesopores in percentage by volume.

3. A CO₂ reversible adsorption composition, comprising, in percentage by weight, 10-90% of the CO₂ reversible adsorption material according to claim 2 and a balance of water; and
preferably, the CO₂ reversible adsorption composition comprises, in percentage by weight, 40 to 60% of the CO₂ reversible adsorption material according to claim 2 and the balance of water.

4. A CO₂ capture method, wherein the capture method uses the CO₂ reversible adsorption material according to claim 2 to capture CO₂ in the air;
preferably, a relative humidity of the air is 20-100%, preferably 30-90%, and more preferably 50-80%; and/or
an ambient temperature during CO₂ capture is 15-80° C., preferably 20-50° C.

5. A regeneration method of the CO₂ reversible adsorption material according to claim 2, wherein the method comprises the step of heating the zinc-aluminum spinel particle after the capture of CO₂ at a temperature of 70-400° C.; and
preferably, the regeneration method comprises the step of heating the zinc-aluminum spinel particle after the capture of CO₂ at a temperature of 10-300° C.

6. The adsorption material according to claim 2, wherein the zinc-aluminum spinel particle has the specific surface area of 230-350 m²/g; and/or
the zinc-aluminum spinel particle comprises 5-13% of micropores, 75-85% of 2-10 nm mesopores and 7-12% of mesopores greater than or equal to 10 nm in percentage by volume.

7. The adsorption material according to claim 2, wherein the zinc-aluminum spinel particle has an average particle size of 2-10 nm, preferably 3-6 nm; and/or;
the zinc-aluminum spinel particle has a pore volume of 0.3-1.2 cm³/g.

8. A method for preparing a zinc-aluminum spinel particle, comprising the following steps of:
S1: respectively preparing a salt solution with a volume of V and containing Zn²⁺ and Al³⁺ and a precipitant solution;
S2: adding an alkali liquor with a pH value of 9-10 into a reaction container, and then dripping the salt solution and the precipitant solution into the reaction container in parallel at a same speed for coprecipitation, wherein, in terms of volume, the pH value is controlled to be 7-9 when the first 20-50% of V is dripped, and the pH value is controlled to be reduced at a reduction range of 1-20% when a rest solution is dripped; and
S3: aging after the coprecipitation is finished, and then drying and calcining an obtained solid at 300-400° C. to obtain the zinc-aluminum spinel particle;
preferably, a molar ratio of Zn²⁺ to Al³⁺ in the salt solution containing Zn²⁺ and Al³⁺ is 0.5-1.5:2; and/or
in the precipitant solution, the precipitant is one or more of sodium carbonate, sodium bicarbonate, potassium carbonate, potassium bicarbonate, ammonium carbonate and ammonium bicarbonate, and a concentration of the precipitant is 0.1-0.5 g/mL.

9. The method according to claim 8, wherein the alkali liquor is an aqueous solution formed by one or more of sodium carbonate, sodium bicarbonate, potassium carbonate, potassium bicarbonate, ammonium carbonate and ammonium bicarbonate, and a concentration of the alkali liquor is 0.05-2 mol/L; and/or
an addition volume of the alkali liquor is 40-60% of V; and/or
in the step S2, a temperature of the coprecipitation is 60-80° C.

10. The method according to claim 8, wherein in the step S3, the aging is carried out at a same temperature as the coprecipitation, and an aging time is 0.5-24 h; and/or
the drying is carried out at 80-120° C. for 10-16 h; and/or
the calcining is carried out at 300-350° C. for 3-6 h.

11. A CO₂ capture method, wherein the capture method uses the CO₂ reversible adsorption composition according to claim 3 to capture CO₂ in the air;
preferably, a relative humidity of the air is 20-100%, preferably 30-90%, and more preferably 50-80%; and/or
an ambient temperature during CO₂ capture is 15-80° C., preferably 20-50° C.

12. A regeneration method of the CO₂ reversible adsorption composition according to claim 3, wherein the method comprises the step of heating the zinc-aluminum spinel particle after the capture of CO₂ at a temperature of 70-400° C.; and
preferably, the regeneration method comprises the step of heating the zinc-aluminum spinel particle after the capture of CO₂ at a temperature of 10-300° C.

13. The adsorption composition according to claim 3, wherein the zinc-aluminum spinel particle has the specific surface area of 230-350 m²/g; and/or
the zinc-aluminum spinel particle comprises 5-13% of micropores, 75-85% of 2-10 nm mesopores and 7-12% of mesopores greater than or equal to 10 nm in percentage by volume.

14. The capture method according to claim 4, wherein the zinc-aluminum spinel particle has the specific surface area of 230-350 m²/g; and/or
the zinc-aluminum spinel particle comprises 5-13% of micropores, 75-85% of 2-10 nm mesopores and 7-12% of mesopores greater than or equal to 10 nm in percentage by volume.

15. The capture method according to claim 11, wherein the zinc-aluminum spinel particle has the specific surface area of 230-350 m²/g; and/or
the zinc-aluminum spinel particle comprises 5-13% of micropores, 75-85% of 2-10 nm mesopores and 7-12% of mesopores greater than or equal to 10 nm in percentage by volume.

16. The regeneration method according to claim 5, wherein the zinc-aluminum spinel particle has the specific surface area of 230-350 m²/g; and/or
the zinc-aluminum spinel particle comprises 5-13% of micropores, 75-85% of 2-10 nm mesopores and 7-12% of mesopores greater than or equal to 10 nm in percentage by volume.

17. The regeneration method according to claim 12, wherein the zinc-aluminum spinel particle has the specific surface area of 230-350 m²/g; and/or
the zinc-aluminum spinel particle comprises 5-13% of micropores, 75-85% of 2-10 nm mesopores and 7-12% of mesopores greater than or equal to 10 nm in percentage by volume.

18. The adsorption composition according to claim 3, wherein the zinc-aluminum spinel particle has an average particle size of 2-10 nm, preferably 3-6 nm; and/or;
the zinc-aluminum spinel particle has a pore volume of 0.3-1.2 cm³/g.

19. The capture method according to claim 4, wherein the zinc-aluminum spinel particle has an average particle size of 2-10 nm, preferably 3-6 nm; and/or;
the zinc-aluminum spinel particle has a pore volume of 0.3-1.2 cm³/g.

20. The regeneration method according to claim 5, wherein the zinc-aluminum spinel particle has an average particle size of 2-10 nm, preferably 3-6 nm; and/or;
the zinc-aluminum spinel particle has a pore volume of 0.3-1.2 cm³/g.
